(19) United States
(12) Patent Application Publication
(10) Pub. No.: US 2003/0210727 A1
(43) Pub. Date: Nov. 13, 2003

(54) Narrowband filter method and apparatus

(75) Inventors: Steven James Frisken, Vaucluse (AU); Dmitri Abakoumov, Lakemba (AU); Glenn Wayne Baxter, Hornsby Heights (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Engana Pty Ltd., Eveleigh (AU)

(21) Appl. No.: 10/141,047

(22) Filed: May 7, 2002

(51) Int. Cl. H01S 3/13; H01S 3/08; H01S 3/10

(52) U.S. Cl. 372/92; 372/98; 372/106; 372/105; 372/20

(57) ABSTRACT

A method of filtering an input optical signal, the method including the step of: (a) utilising the phase response of a Gires-Tournois resonator to produce a corresponding spatial separation in a predetermined wavelength range of the input optical signal. The method further preferably can include the step of: (b) projecting substantially orthogonal beams onto the surface of a Gires-Tournois resonator at slightly different angles of incidence and utilising the phase difference in the phase response of the orthogonal beams to spatially separate the predetermined wavelength range. A birefringent wedge can be utilised to separate a polarised input beam into the substantially orthogonal beams for projection onto the surface of the Gires-Tournois resonator.

### BACKGROUND OF THE INVENTION

1. Field of the Invention

The present invention relates to the field of filtering of electro-magnetic waves, in particular optical light waves in telecommunications systems. The present invention discloses a method and apparatus for providing narrowband filters of high selectivity.

Often, it is extremely important to be able to filter particular wavelengths of an input signal. For example, in the field of optical telecommunications, many optical signals may be present in an optical waveguide having different wavelengths. It is often desirable to extract one of the wavelengths independently of the others or manipulate the wavelength. Ideally, the wavelength is desirably extracted in a highly selective manner to the exclusion of the others. This is particularly the case for wavelength division multiplexed (WDM) optical communications systems where there is a high requirement for transmission bandwidth sufficient to allow a full signal to be transmitted (plus guard bands) without degradation whilst providing for a maximum extinction of non-filtered channels.

The required characteristics to remove an optical channel from a WDM system has been achieved previously by:

i) in fibre Bragg gratings produced holographically on photosensitive waveguides;

ii) arrayed waveguide gratings;

iii) dielectric multicavity filters;

iv) etalon or cavity filters.

Although each of the above approaches has its relative strengths and applications, none of the approaches offer a satisfactory approach to tunability, ease of manufacture, extinction of other channels and the ability to drop channels without disrupting non-dropped traffic.

Polarization approaches to wavelength filtering have previously been based on multiple stacks of birefringent plates (U.S. Pat. Nos. 5,694,233; 6,288,807; 6,137,606; 5,978,166; 5,867,291) or have been used to produce interleaving filters (U.S. Pat. Nos. 6,234,200; 6,169,604; 6,215,926; 6,169,828; 6,263,129; 6,310,690) but no simple technique has been proposed for a narrow band large Free Spectral Range filter.

### SUMMARY OF THE INVENTION

An object of the present invention provide for an improved filter device.

In accordance with a first aspect of the present invention, there is provided a method of filtering an input optical signal, the method including the step of: (a) utilising the phase response of a Gires-Tournois resonator to produce a corresponding spatial separation in a predetermined wavelength range of the input optical signal. The method further preferably can include the step of: (b) projecting substantially orthogonally polarised beams onto the surface of a Gires-Tournois resonator at slightly different angles of incidence and utilising the phase difference in the phase response of the orthogonal beams to spatially separate the predetermined wavelength range. A birefringent wedge can be utilised to separate an input beam into the substantially orthogonal beams for projection onto the surface of the Gires-Tournois resonator.

In accordance with a further aspect of the present invention, there is provided a method of filtering an input optical signal, the method including the steps of: (a) imparting a relative phase delay to a predetermined wavelength range of an input optical signal; (b) spatially separating portions of the optical signal based upon the relative phase delay of components of the optical signal.

In accordance with a further aspect of the present invention, there is provided an apparatus for filtering a first optical signal from a series of optical signals the apparatus comprising: an input optical waveguide; a first polarization translation element spatially translating substantially orthogonal polarization states emitted from the input optical waveguide so as to produce spatially separated orthogonal states; a first birefringent wedge for separating at least one of the substantially orthogonal polarization states into further sub-components having different trajectories; a polarization manipulation element for optionally applying a polarization manipulation to the sub components; an optical phase delay element for applying a wavelength dependant phase delay to the sub components; a second birefringent wedge for combining the separated sub-components so as to produce a combined component; a second polarization translation element for spatially translating the combined component depending on its polarization state; and wherein light from the first optical signal is transmitted towards a first spatial output location and light from the series of optical signals is transmitted to a second spatial output location

The optical phase delay element can comprise a tunable Gires-Tournois resonator. The phase delay of orthogonal polarization states projected onto the Gires-Tournois resonator are preferably independently tunable. One of the orthogonal polarization states can be tunable by alteration of an electric field across a liquid crystal and the other can be tunable by changing the dimensions or refractive index of the cavity. The Gires-Tournois resonator preferably can include a liquid crystal filled cavity.

In one embodiment, the polarization manipulation element imparts a tunable polarization manipulation to the sub components.

The system can further include an output waveguide located at the position of at least one of the first spatial output location or the second spatial output location and a polarization rotation element between the second birefringent plate and the second polarization translation element for applying a half wave manipulation to the combined component. Further the apparatus can include a polarization rotation element between the first polarization translation element and the first birefringent plate for applying a half wave manipulation to the spatially separated orthogonal polarization states. The apparatus can also include a collimating lens for collimating the output from the input optical waveguide.

In proposed designs, the first polarization translation element also acts as the second polarization translation element and the first birefringent plate also acts as the second birefringent plate. Ideally, the device acts in a reflective mode with the input optical waveguide and the first spatial output location are preferably at a first proximal end of the device and the optical phase delay element can be located at a second distal end of the device.

In accordance with a further aspect of the present invention, there is provided an apparatus for filtering a first optical signal from a series of optical signals, the apparatus comprising: an input optical waveguide; a first polarization translation element spatially translating substantially orthogonal polarization states emitted from the input optical waveguide so as to produce spatially separated orthogonal states; a first birefringent element for separating at least one of the substantially orthogonal polarization states into further sub components having different trajectories; a polarization manipulation element for applying a polarization manipulation to one of the sub components; at least one optical phase delay element for independently applying a wavelength dependant phase delay to each of the sub components; a second birefringent element for combining the separated sub components so as to produce a combined component; a second polarization translation element for spatially translating the combined component depending on its polarization state; and wherein light from the first optical signal is transmitted towards a first spatial output location and light from the series of optical signals is transmitted to a second spatial output location.

In accordance with a first aspect of the present invention, there is provided a laser cavity including: a first reflector at a first end of the cavity; a light pump emission source; a first birefringent element for projecting substantially orthogonal polarizations of light in slightly different directions; a first polarization rotation element adapted to apply a predetermined polarization manipulation to the projected orthogonal polarizations; a partially reflective optical phase delay element for applying a phase response to reflected portions of the projected orthogonal polarizations and outputting a transmitted portion of the projected orthogonal polarizations.

Preferably, the light reflected from the optical phase delay element traverses a second polarization rotation element and a second birefringent element upon reflection, with the light traversing the second polarization element before traversing the second birefringent element.

In one embodiment, the first and second polarization rotation elements are preferably the same element. The first and second polarization rotation elements can be preferably quarter wave plates. The partially reflective optical phase delay element can comprise a Gires Tournois (GT) resonator having a tunable phase delay.

Preferably, the system also includes a focussing element for collimating light from the light pump emission source.

In accordance with a further aspect of the present invention, there is provided a method of providing a quality laser output source, the method including the steps of: (a) within a resonant cavity of the laser device, utilising a series of elements so as to impart a selective polarization manipulation to a predetermined wavelength range; (b) utilising the selective polarization manipulation of the predetermined wavelength range in a feedback loop so as to tune the laser to the predetermined wavelength range.

The series of elements can include a birefringent plate, a quarter wave plate and a partially reflective optical phase delay element. The partially reflective optical phase delay element can comprise a Gires Tournois resonator.

In accordance with a further aspect of the present invention, there is provided a device for selecting at least a first optical signal from a series of optical signals, the device including: an input port; at least a first output port; a photonic manipulation unit comprising: a first polarization separation element for spatially separating and aligning light orthogonal polarization states emitted from the first output port to formed an aligned polarization signal; a first phase controller for providing a variable phase delay between the components of the aligned polarization signal so as to form a delayed polarization signal; a first walkoff composite element for walking off separate components of the delayed polarization signal so as to form a walked off signal, the walk off signal including further sub components having different trajectories, an optical phase delay element for applying a wavelength varying phase response to the walked off signal to produce phase varying optical signals; a second walkoff composite element for combining the phase varying optical signals so as to produce a polarization varying optical signal including a polarization state variation for a first predetermined range of wavelengths relative to a second predetermined range of wavelengths of the polarization varying optical signal; a second polarization separation element for combining the first predetermined range of wavelengths emitted from the first output port and a reflective element including a series of reflective strips, wherein light of the second predetermined range of wavelengths is reflected back through the photonic manipulation element.

The light of the second predetermined range of wavelengths can be reflected back through the photonic manipulation unit where it can be combined at a second output port. The light of the second predetermined range of wavelengths can be reflected back through the photonic manipulation unit wherein a third predetermined range of wavelengths can be separated from the second range of wavelengths, where it can be combined at a third output port, with the remaining light from the second predetermined range of wavelengths being combined a second output port. The first predetermined range of wavelengths can be variable.

The photonic manipulation unit further can comprise a first polarization alignment element for polarization state aligning of the walked off signal so as to form aligned polarization signals.

In accordance with a further aspect of the present invention, there is provided a method of separating a first optical signal from a series of optical signals, the method including the step of: interfering two polarization sub-components of the series of optical signals, the sub-components having differing phases.

The differing phases are preferably formed by different angular propagation through a Gires Tournois interferometer. The differing phases can be formed by separating linearly polarised input light into the two polarization sub-components having slightly differing trajectories; and projecting the polarization sub-components against a Gires Tournois interferometer. The Gires Tournois interferometer can have an adjustable phase response.

In accordance with a further aspect of the present invention, there is provided a method of manipulating an input optical signal including the step of: (a) inducing a relative resonant wavelength phase shift between two polarization sub-components of the optical signal. The inducing step preferably can include projecting the two polarization sub-components against a Gires Tournois resonator at slightly different angles of incidence.

Further, the method can also include the step of interfering the two polarization sub-components together so as to produce a first output signal having a polarization variation with respect to wavelength. The method can also include the step of: (c) utilising the polarization variation to spatially separate different wavelengths of the input signal.

The method can be utilised in separating a first wavelength signal from a series of wavelength signals.

In accordance with a further aspect of the present invention, there is provided a method of tuning a wavelength selective optical device including a polarization manipulation element, the method including the steps of: (a) initially setting the polarization manipulation element to a first state, including a polarization encoding of the wavelength; (b) adjusting the polarization manipulation element to reduce or remove the polarization encoding of wavelength selectivity; (c) wavelength tuning the phase response; and (d) readjusting the polarization manipulation element to the first state, including a polarization encoding of the wavelength.

Preferably, the step (c) can comprise manipulating the phase response of a Gires-Tournois resonator and the step (b) preferably can include aligning the input polarisation state to an axis of the Gires-Tournois resonator. The polarisation manipulation element can comprise a variable polarisation rotation element.

### BRIEF DESCRIPTION OF THE DRAWINGS

Preferred and other embodiments of the present invention will now be described with reference to the accompanying drawings in which:

FIG. 1 illustrates schematically the operation of a Gires Tournois (GT) resonator;

FIG. 2 illustrates the phase response of a GT resonator;

FIG. 3 illustrates schematically a first component of an embodiment;

FIG. 4 illustrates a first series of polarization state transitions for the arrangement of FIG. 3;

FIG. 5 illustrates a second series of polarization state transitions for the arrangement of FIG. 3;

FIG. 6 illustrates schematically the splitting of light by a birefringent wedge;

FIG. 7 illustrates the phase response for two rays striking a GT resonator at slightly different angles;

FIG. 8 illustrates schematically a second component of an embodiment;

FIG. 9 illustrates a first series of polarization state transformations for the arrangement of FIG. 8;

FIG. 10 illustrates a second series of polarization state transformations for the arrangement of FIG. 8;

FIG. 11 illustrates the calculated filter response for embodiments of the present invention;

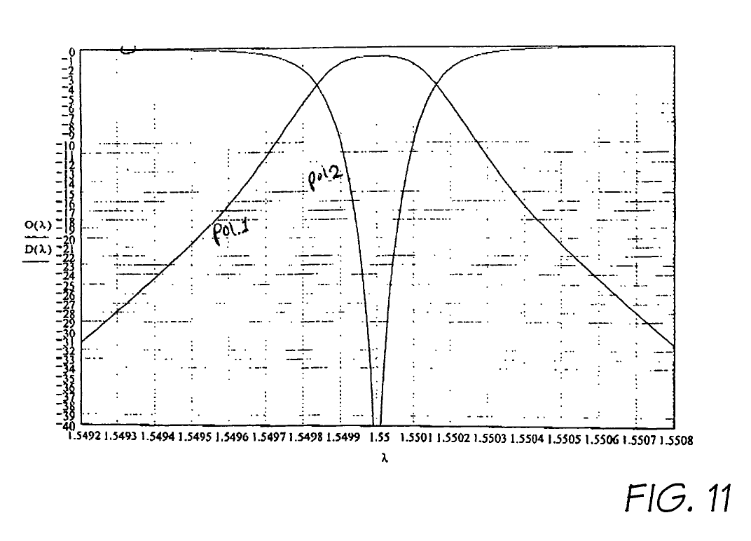

FIG. 12 illustrates schematically an exploded perspective of a first embodiment of the present invention;

FIG. 13 illustrates a first ray passing through the arrangement of FIG. 12;

FIG. 14 illustrates a second ray passing through the arrangement of FIG. 12;

FIG. 15 illustrates a third ray passing through the arrangement of FIG. 12;

FIG. 16 illustrates a fourth ray passing through the arrangement of FIG. 12;

FIG. 17 illustrates a schematic exploded perspective view of a further embodiment;

FIG. 18 illustrates a schematic exploded perspective view of a further embodiment;

FIG. 19 illustrates a schematic exploded perspective view of a further embodiment;

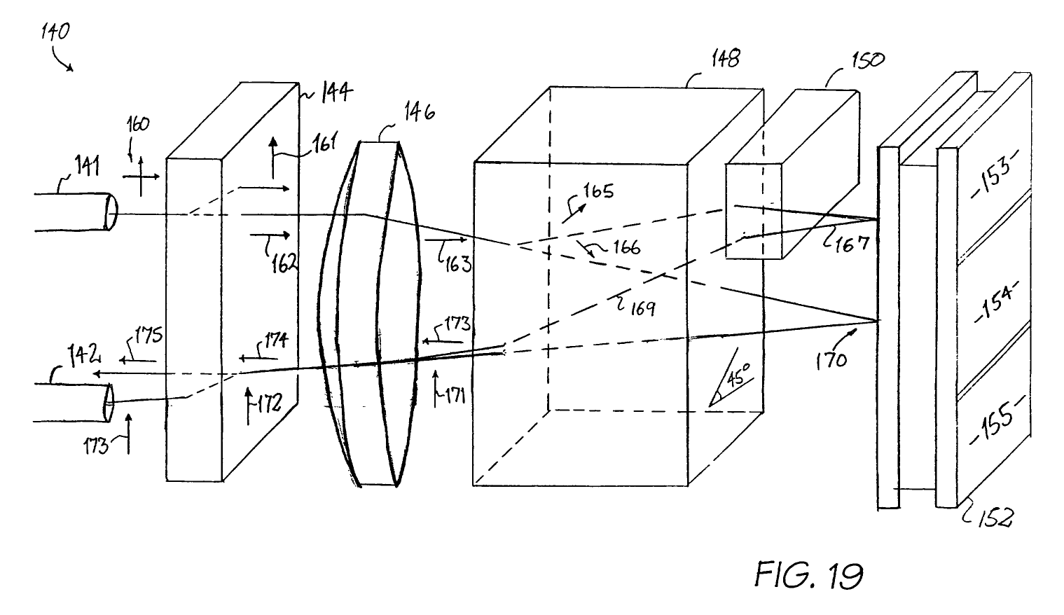

FIG. 20 illustrates a schematic exploded perspective view of a further embodiment;

FIG. 21 illustrates schematically the ultilisation of the principles of the present invention in a laser cavity system.

### DETAILED DESCRIPTION OF THE INVENTION

In the preferred embodiment, there is provided a technique for producing a spectrally dependent polarization transformation which is of a narrowband nature and is tunable and offers an improved spectral shape or characteristic.

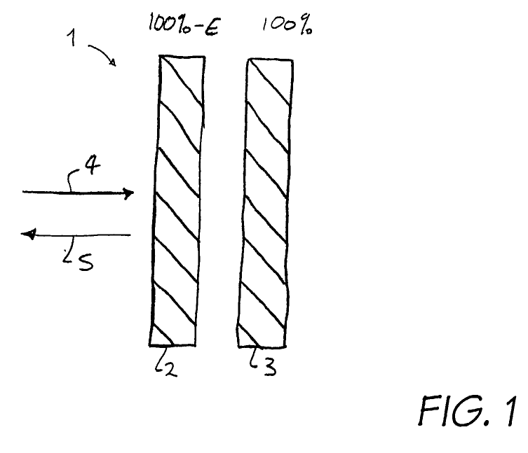

The arrangement of the preferred and other embodiment utilises a Gires Tournois (GT) resonator and takes advantage of the resonators fundamental properties. A GT resonator is illustrated schematically in FIG. 1 and is a simple optical resonator cavity formed between two plates 2,3. The first plate 3 is designed to have 100% reflectivity. The second plate 2 is designed to have close to but less than 100% reflectivity so that, in the absence of absorption, all light projected onto the cavity 1 is effectively reflected 5; In the present case, the GT resonator can be extended to include the case where a significant fraction of the light is not reflected back due to absorption or lack of reflectivity of the back mirror 3 being less than 100%.

It will become apparent that it is possible to achieve the required phase responses necessary for effective operation of embodiments of the invention with a variety of cavities where the back mirror reflection 3 is greater than the front mirror reflection 2. Further, there are advantages such as monitoring of input signals in not having non-complete reflection of the mirror 3. Further, the invention extends to other portions of the electromagnetic spectrum.

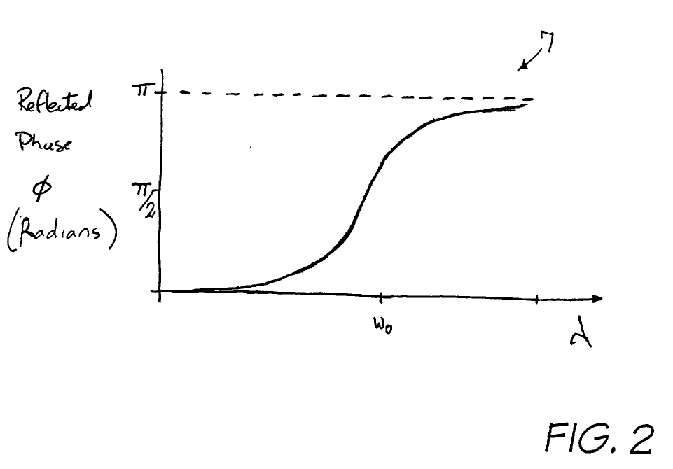

A GT resonator has the advantageous property that the phase response changes with wavelength. A schematic illustration of the phase response is provided in FIG. 2 which illustrates the phase response change with respect to wavelength. In the arrangement in FIG. 2, the phase response 7 goes through a transition around a resonant frequency coo.

In the preferred embodiments, use is made of this principle to produce a wavelength depend phase for a first polarization state and to produce, for a second polarization state, a wavelength shifted (but otherwise similar) phase response, such that the difference of the two phase responses will result in light incident with polarization axis approximately 45° to the axis of the GT resonator so as to include a very narrow band of light which is rotated, whilst leaving the other channels or frequencies unchanged. By spatially separating out the light which is rotated from the light which is unchanged, it is possible to filter the light so as to produce an add-drop filter.

In order to fully comprehend the operation of the preferred embodiments, a number of instructive sub component examples will be first considered.

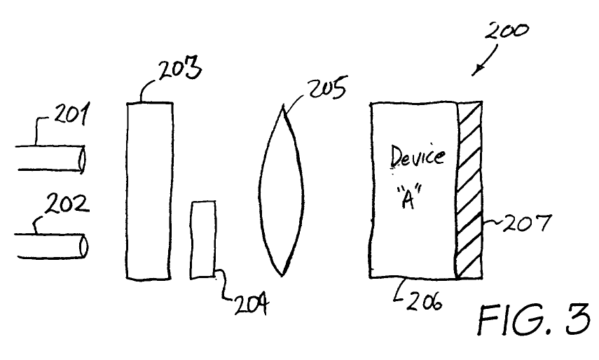

Turning to FIG. 3, there is illustrated an initial illustrative device 200 which includes an input and output fibre 201, 202. Next, a walk off plate 203 is provided which separates orthogonal polarization states. A half wave plate 204 provides for a 90 degree rotation of transmitted polarization states. A lens 205 is provided to collimate transmitted beams. Next, there is provided a device 206 which is a device which performs operations on the polarization state in a wavelength dependent manner. The device also includes a reflective component 207 which provides for reflection of an inputted beam from the direction of the input waveguide 201 to the direction of the output waveguide 202.

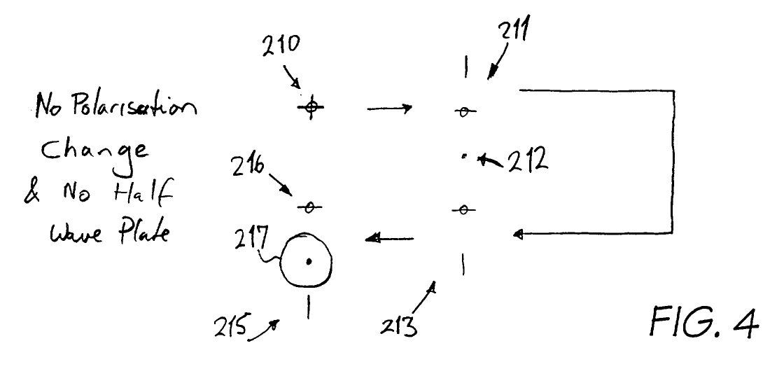

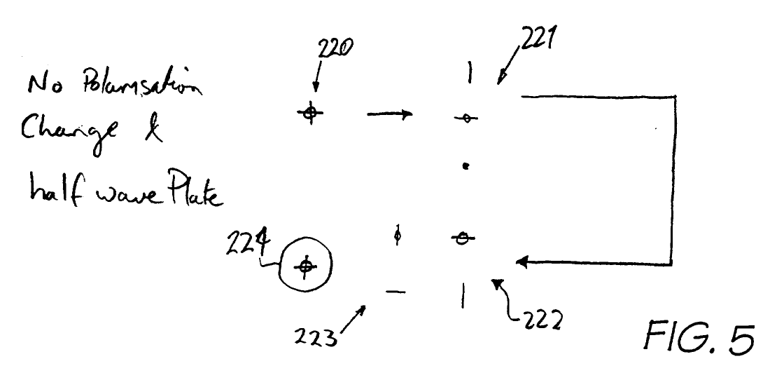

Turning to a first example series of polarization state transitions shown in FIG. 4 there will now be discussed the case where the device 206 does not induce any polarization changes and no half wave plate 204 is present. In this case, the input polarization states transmitted from input waveguide 201 are spatially aligned 210. The half wave plate acts to spatially separate the polarization states 211. The lens 205 has no affect on the polarization state and they are reflected around an axis of symmetry 212 so as to produce output polarization states 213. The output polarization states 213 are unchanged with respect to the input polarization states 211. The walk off plate 203 then translates only the bottom polarization state 215 leaving the top polarization state 216. The two polarization states 215, 216 are output around a target zone 217 of the output fibre 202 and hence no light is transmitted to the output fibre 202 for this case. The case for the insertion of the half wave plate 204 in FIG. 3 is illustrated in FIG. 5 with the polarization states 220 to 222 being the same as those of FIG. 4. The half wave plate 204 produces a 90° rotation in the polarization states 223. As a consequence, the walk off plate 203 combines the two polarization states which are then output aligned at the output fibre 224. Hence, the input light is transmitted.

It would be further evident that where the device 206 provides for a 90° rotation of the input polarization state then the opposite to that occurring in FIG. 4 and FIG. 5 will occur.

In preferred arrangements, the device A (206) selectively provides for a 90° rotation of the polarization input state. The selectivity is controlled in accordance with wavelength through the use of GT resonator as will be described in more detail hereinafter.

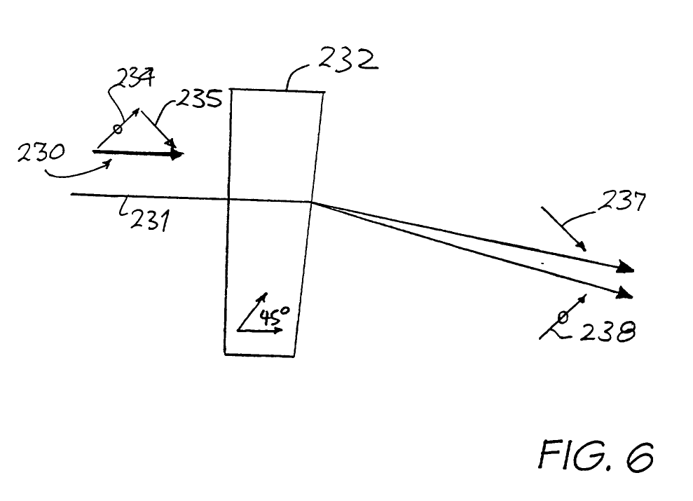

The preferred embodiment also utilises a birefringent plate so as to produce a complex phase interrelationship as will become more apparent hereinafter. Turning now to FIG. 6, there is illustrated the operation of a birefringent plate 232 having a fast axes as 45° horizontal. In this case, an input horizontal polarization 230 is input along beam 231. The birefringent plate 232 has its fast access at 45° to the horizontal. Hence, the input polarization state can be divided into two components 234, 235. The component 234 being along the fast access of the crystal 232 and the component 235 being orthogonal to the component 234. The birefringent crystal 232 acts to separate the two components 234, 235 into separate rays 237, 238. The two components 237, 238 are projected at slightly different angles out of the crystal 232.

As they are at slightly different angles, the two will experience slightly different reflection phase response curves when transmitted to a GT resonator.

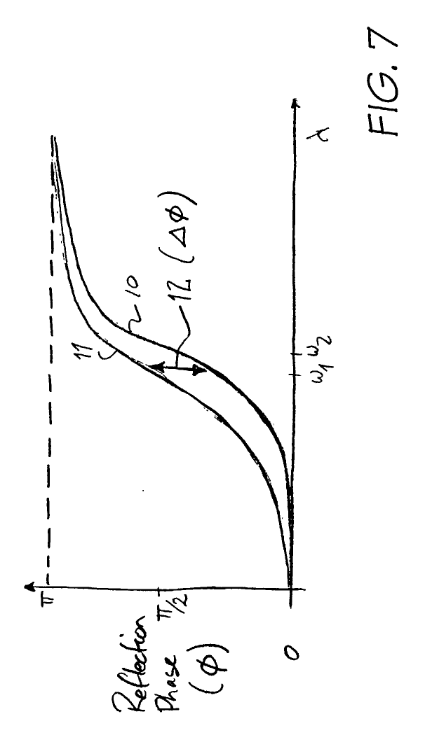

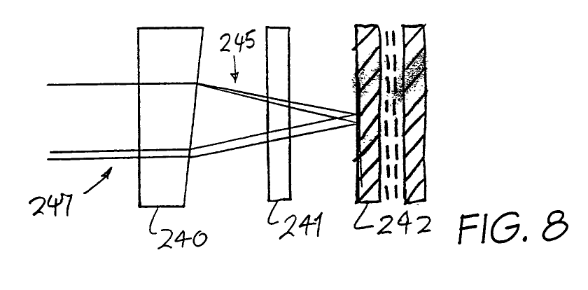

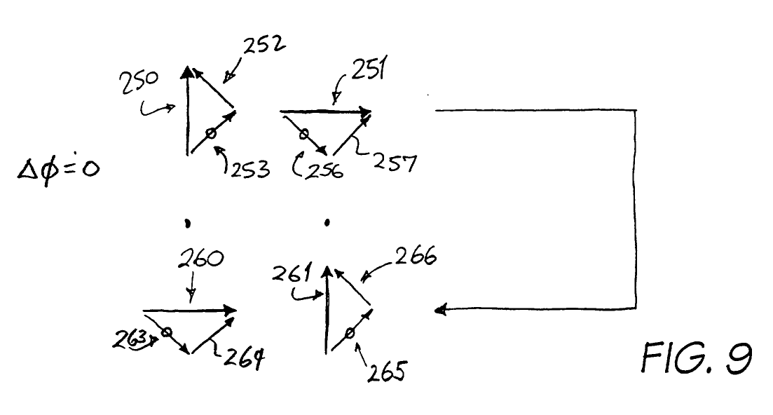

Turning now to FIG. 7, there is illustrated two phase response curves 10, 11 experienced by slightly different angled rays striking a GT resonator. The nature of each curve 10, 11 will depend on the angle of the rays. The phase difference ΔΦ12 between the two responses can be seen to rise and fall quite rapidly. This difference 12 can be utilised to provide the basis for a wavelength specific filtering of the transmitted light. Turning to FIG. 8, there is illustrated schematically one form of the device A which can comprise a birefringent crystal 240 a quarter wave plate 241 which provides, in total, a half wave rotation of the out and return beam. Further, a GT resonator device 242 is provided. The quarter wave plate 240 projects orthogonal beams e.g., 245 at slightly different angles. The two orthogonal beams are reflected from the GT resonator with a phase difference as illustrated in FIG. 7. They are then effectively recombined on the return path 247.

Where no phase difference exists between the two components, the situation is as illustrated in FIG. 9. In this situation each of the vertical 250 and horizontal 251 polarization states can be divided into sub-components 252, 253 and 256, 257 where no phase difference exists, the quarter wave plate 241 acts to provide an overall 90° rotation of the polarization components resulting in components 260, 261.

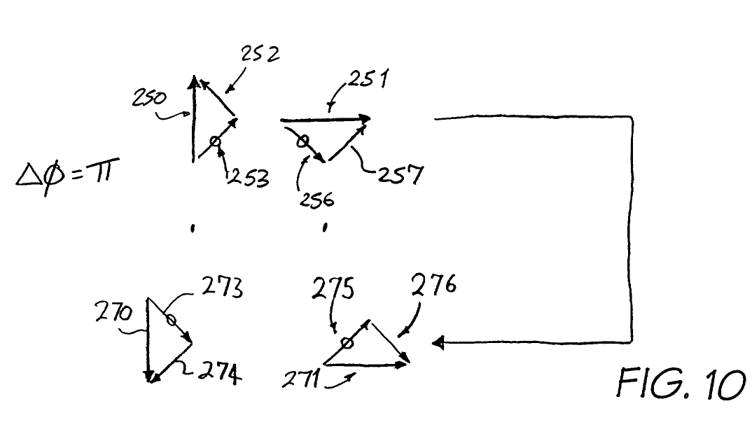

In the situation where the phase difference ΔΦ of FIG. 7 is equal π radians, the situation resulting is as illustrated in FIG. 10 wherein the input polarization components 250, 251 undergo transformation to output components 270, 271. The output component 270 is made up of self components 273, 274 with the component 273 corresponding to the component 263 and the component 274 corresponding to the component 264 but delayed relative to the component 264 by Π radians. Similarly, the polarization component 271 can be divided into sub-components 275, 276 with the component 276 delayed by π radians relative to the component 266. As a result, the component 270 is rotated by 90° relative to the component 260 and the component 271 is rotated by 90° relative to the component 261.

As the phase difference of π radians occurs only in a small wavelength range, the nature of the responses of FIG. 9 and FIG. 10 can be utilised to perform filtering functions. Further, by altering the spatial distance between the birefringent plate 240 and GT resonator 242 of FIG. 8, angle adjustments can be made and therefore tuning of the two response curves in FIG. 7 can be implemented.

As a result, a wide passband filter having a variable passband can be achieved with a strong “flat-top” characteristic. Further, high extinction of light from neighbouring channels can be achieved. Devices implementing the approach can be of a low cost and polarization separation is simple to implement to separate out the filtered light. Further, low chromatic dispersion can be achieved over the passband by suitable choice of wavelength separation for a given cavity finesse resulting in a flat group delay over the pass band for the resultant polarization separated wavelength.

The high quality passband characteristics can be seen from FIG. 4 where, there is illustrated the calculated corresponding filter characteristics for different input polarizations.

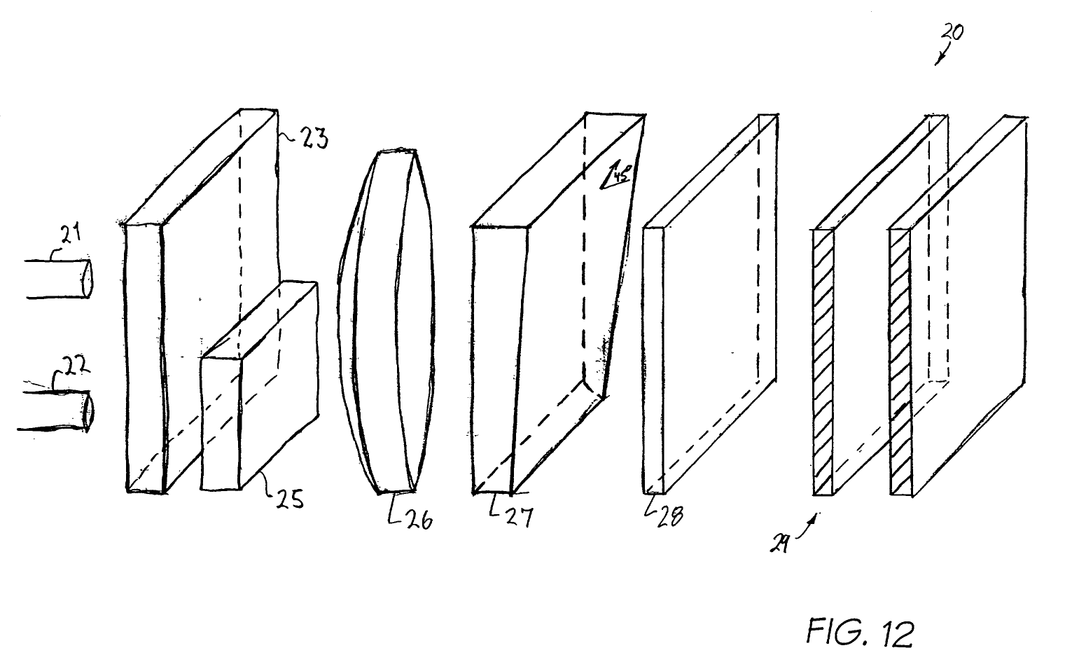

Turning now to FIG. 12, there is illustrated schematically an exploded perspective view of a first filtering device 20 which is constructed to take advantage of the aforementioned GT resonator properties. In the arrangement 20, there is initially provided input and output fibres 21, 22 respectively. Next, a walk-off plate 23 is provided which spatially separates the polarization state of input light and, where required, combines the polarization state of output light. Next, a halfway plate 25 is provided in the bottom portion of the device 20 so that it interacts with light being transmitted towards fibre 22. A lens 26 acts to collimate the input and output beam and its position can be varied in accordance with requirements. Next, a birefringent plate 27 is provided at an angle of approximately 45° to the horizontal. The birefringent plate 27 separates orthogonal polarization components into different output trajectories.

Next, a quarter-waveplate 28 provides for a relative quarter-wave retardation of orthogonal polarization with an equivalent half-wave rotation for out and return paths.

Next, a GT resonant cavity 29 is provided having a resonance point at the desired filtering frequency.

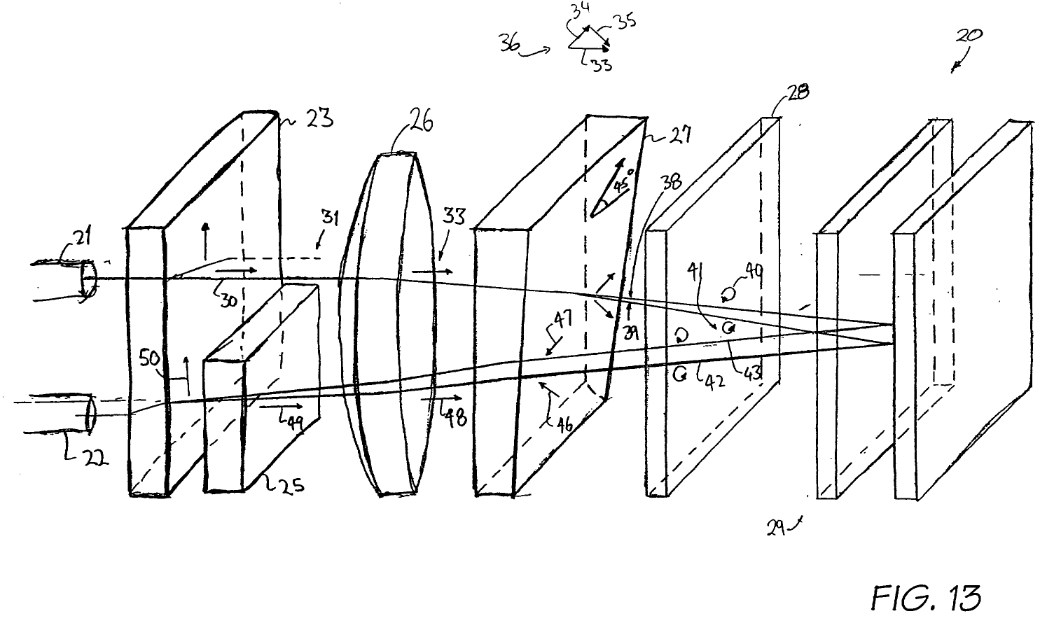

Turning now to FIG. 13, there is illustrated a first series of rays through the arrangement 20. The light exits the input optical waveguide 21 and is projected through walk-off plate 23. The light is spatially separated into orthogonal polarization components by the walk-off plate 23 and the orthogonal components 30, 31, being spatially separated, continue separately through the device. Initially, only the horizontally polarised component 30 will be considered in FIG. 13 with the other vertical component 31 being discussed elsewhere and generally acting in a similar manner. The horizontal component 30 passes through lens 26 where it is collimated but undergoes no change in the polarization state 33.

The birefringent wedge 27 has its axis set at 45° to the horizontal, and therefore, the input polarization component 33 is divided into two output components 34, 35, one being parallel to the polarization axis of the plate 27 and one being orthogonal to the polarization axis. The arrangement 36 showing the vector component resolutions. The output from the birefringent wedge 27 is therefore two components 38, 39 with each of the components 38 and 39 having orthogonal polarization components and slightly different trajectories. The two components 38, 39 pass through the quarter-waveplate 28 where they are transformed to optical polarization states 40, 41. The two rays are then reflected by the GT cavity 29 where they undergo a relative phase change in accordance with the previous discussion. Given the two rays 38, 39 are slightly angularly off-set from one another, the first ray will undergo the phase change 10 with respect to a first resonant wavelength and the second ray 41 will undergo the phase change 11 with respect to a second resonant wavelength. The reflected rays 42, 43 again have elliptical polarization states.

After passing through the quarter waveplate, the total rotation experienced by the ray will be 90° for each polarization component before recombination. The birefringent wedge 27 acts to angularly recombine the polarization states 48 which are then further collimated by lens 26. In this case, for wavelengths between the resonances, there is an additional phase shift between the polarization components such that the combined vector is no longer orthogonal to the incoming polarization 33, but has a significant component 48 (maximum when the phase shift is pi) which is now horizontal. The output polarization state 49 is flipped through 90° 50 by halfway plate 25. The walk-off plate 23 acts to translate the polarization state where is it subsequently output to the fibre 22.

It is noted previously, the two sub-components 38, 39 are projected onto the GT resonator at slightly different angles. Hence, they experience a slightly different resonant wavelength. Further, only the light which is rotated by 90° degrees is recombined by the birefringent wedge upon reflection. The 90° rotation is introduced by the quarter waveplate 28 placed at the 45° axis. Alternatively, a Faraday rotator could be used in place of the quarter waveplate 28. The polarization output state of the combined rays as determined by the phase difference Δφ between the two rays will therefore be different for the resonant and non-resonant case.

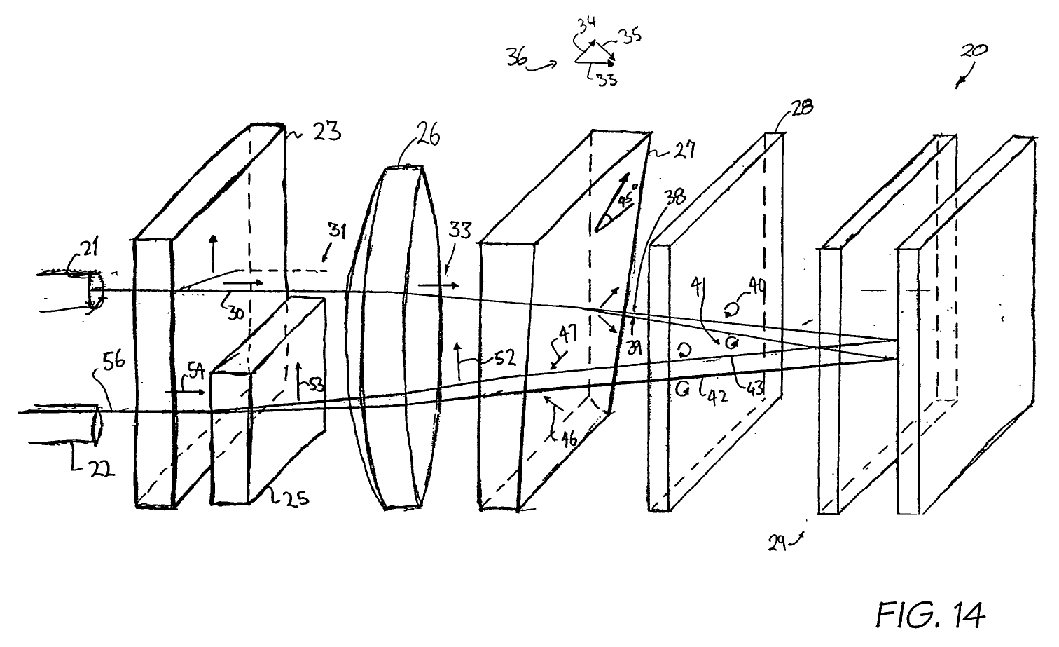

In FIG. 14, there is illustrated the case when the light is away from the resonant wavelengths and the GT resonator provides only a small relative phase delay. The arrangement is similar to FIG. 13, however, the output polarization 52 is not affected on recombination by a relative phase shift and so remains with only the 90 degree rotation provided by the double pass of the quarter waveplate. As a consequence, the polarization state 53 is rotated by 90° 54 by halfway plate 25 (in accordance with the discussion of FIG. 8 to FIG. 10) and the walk-off plate 23 does not translate the resonate frequency. As a result, the output beam 56 misses the fibre 22 on output.

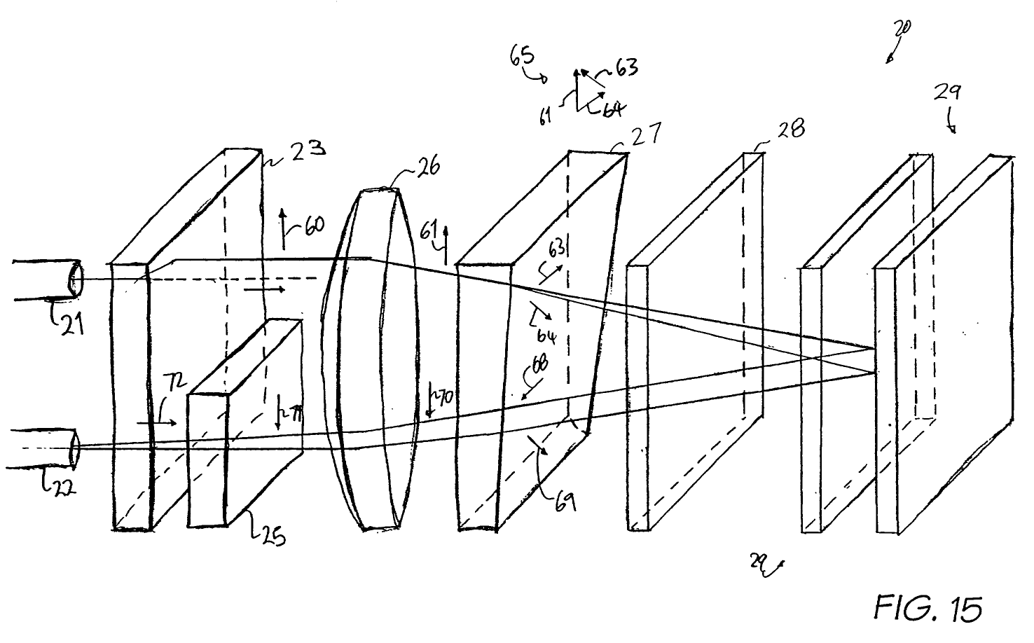

Whilst the alternative polarization states (31 of FIG. 6) operates substantially symmetrically, it will now be described so as to further clarify the operation of the embodiment. Turning initially to FIG. 15, there is illustrated a first resonant case for the vertical polarization case 60 when exiting the walk-off plate 23. The vertical polarization 60 is unaffected by the collimating lens 26 so as to output polarization state 61. The birefringent wedge 27 results in the division of the polarization state 61 into components 63, 64 in accordance with the vector diagram 65 The two components 63, 64 have a slightly different trajectory similar to that noted previously with reference to FIG. 6. After transmission through component 28 and reflection from the GT resonator 29, the resulting polarization states are indicated 68, 69. The two polarization states are combined 70 by birefringent wedge 27 wherein they are further collimated 71 by lens 26 and rotated 72 by half-way plate 25. The light 72 is transmitted through the walk-off plate 23 without spatial translation to the output fibre 22.

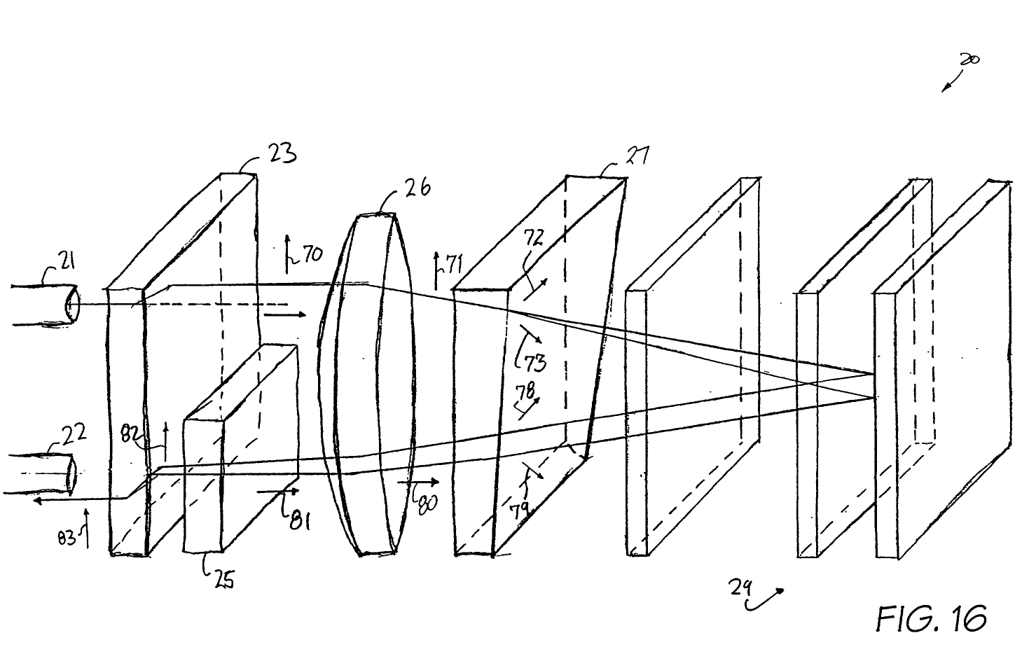

In FIG. 16, there is illustrated the arrangement away from resonance. The polarization states 71-73 are equivalent to the state 61-64 of FIG. 15. However, away from resonance, the polarization states 78, 79 differ from the states 68, 69 in that the summation of the two states 78, 79 results in polarization state 80. The output polarization state is transmitted through lens 26 in an unaltered state 81. The halfway plate 25 provides a rotation 82 of the polarization state. The polarization state 82 is then spatially translated by the walkoff plate 23 to produce output polarization state 83 which is translated so that it misses the optical fibre 22.

It can therefore be seen from analysis of FIG. 12 to FIG. 15 that the arrangement 20 provides for a system whereby light is transmitted from the input port to the output port when it is within the resonant region whilst light away from the resonant frequency is transmitted from the input port away from the output port. In this way, the arrangement 20 operates as a filter device with the filtering characteristics set by the phase characteristics of the GT resonator 29.

Further, it will be apparent that, through the omission of the half-way plate 25, the opposite effect can be achieved in that at resonance, the light is transmitted away from the output fibre 22 whilst away from resonance the light is transmitted to the output port 22.

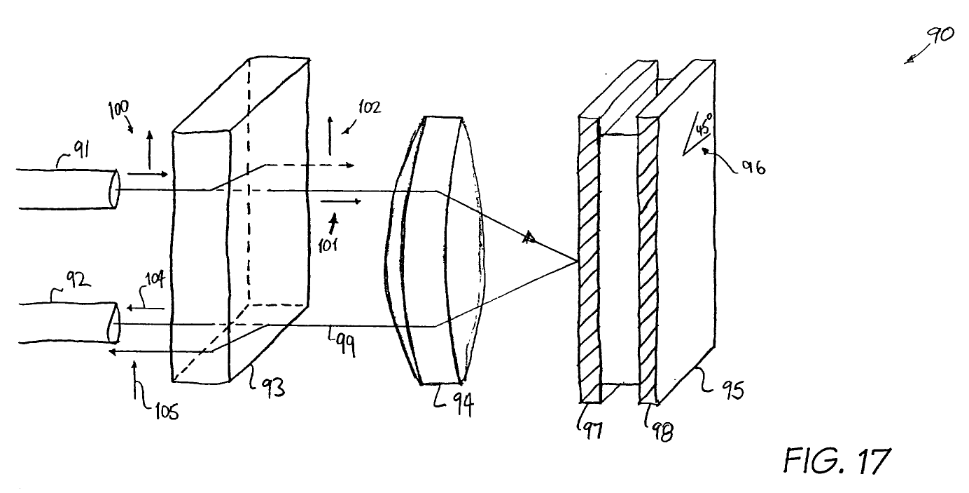

Other arrangements utilising the phase properties of GT resonators are possible. For example, in FIG. 17, there is illustrated a further simple arrangement 90 which includes input and output fibre 91, 92, a walk-off plate 93, a lens 94 and a GT resonator having an adjustable birefringence 95. The GT resonator 95 preferably allows tuning in both the ordinary refractive index (nₒ) and the extraordinary refractive index (nₑ). One of the axis (nₒ, nₑ) can be tuned thermally so as to change the resonate properties of the two plates 97, 98. By forming a liquid crystal between the two plates 97, 98, the other axis can be tuned electronically by changing the electric field between the two plates 97, 98. Taking a ray traced through the system 90, the light output from fibre 91 contains both polarization states 100. They are spatially separated by walk-off plate 93 so as to provide polarization states 101, 102. Only the horizontal polarization state 101 will be considered further with the vertical polarization state 102 acting analogously. The light 101 is collimated by lens 94 before being transmitted to the surface of the liquid crystal GT resonator 95. The liquid crystal GT resonator is placed at an axis of 45° to the horizontal. When the light is reflected from the surface of the resonator, it will have a variable phase change depending on the resonance properties of the liquid crystal GT resonator 95. Subsequently, the light is further collimated by lens 94 and, depending on the phase state, the horizontal component of light 99 is transmitted 104 to the output port 92, with the vertical component 105 being translated so as to miss the fibre 92. The portions 104, 105 can be controlled by controlling the thermal and electrical properties of the GT resonator 95.

Where the ordinary refractive index (nₒ) and extraordinary refractive index (nₑ) are such that the resonant wavelength difference (λ(o)−λ(e))=δ is small (approximately equal to the resonant bandwidth) then the GT resonator can be used directly to control the reflected polarization state for light incident at 45° to the axis. The phase response for ordinary and extraordinary axis is again given by FIG. 2.

Where nₒ is tuned such that the λ(o) lies out of band, then a narrowband polarization is achieved but with a lower level of discrimination between the passband and the rejected light. This may have applications in multiplexing signals together with low loss. In this case the phase response is linear for the ordinary polarization state and the phase difference can approach π at the centre of the resonance for the extraordinary polarization state.

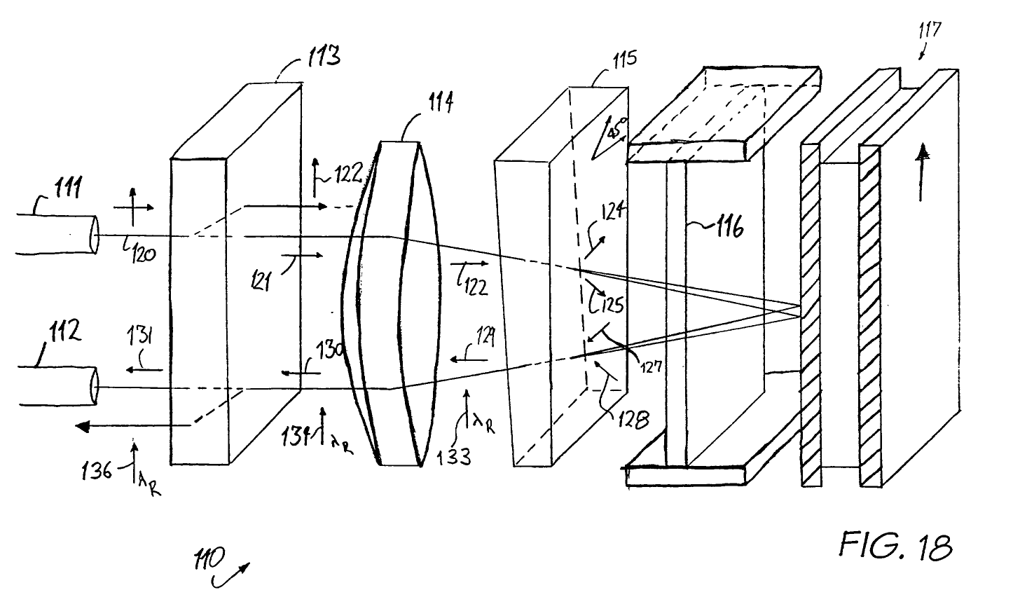

Turning now to FIG. 18, there is now illustrated a further embodiment which combines the features of FIG. 17 with those of FIG. 12. In the arrangement 110 there is provided input and output fibres 111, 112 as usual. A walk-off plate 113 is used to separate orthogonal polarization states, a lens 114 collimates the output and return beams; a birefringent wedge 115 is placed at 45° horizontal and acts to separate input beams into polarization components. Next a Faraday rotator 116 is provided. The Faraday rotator (or reciprocal rotator) provides a 45 degree rotation. In the present case, the out and return path are set to provide an equivalent 90 degree rotation of the traversing light. Next, the GT resonator 117 provides a wavelength dependent phase delay of the polarization state of effected light.

Taking a first example, the input light 120 is separated into horizontal 121 and vertical 122 components. Taking the case firstly of the horizontal component 121, it is transmitted through lens 114 in an unaltered state 122. The polarization state then is transmitted through the birefringent plate 115 which has an axis at 45°. The output light is divided into orthogonal components 124, 125 having slightly different trajectories. The components are phase delayed by the Faraday rotator 116 and further phase delayed in a wavelength dependent matter by GT resonator 117. The output beam is again transmitted through Faraday rotator 116. The two polarization states 127, 128 are combined 129 by birefringent plate 115. They are then transmitted through lens 114 to produce polarization state 130 which is unaffected by walk-off plate 113 to produce polarization state 131 which is output at output waveguide 112.

At the resonant frequency, the polarization state output from is rotated by 90° relative to the delay at the non-resonant points. Hence, the output of birefringent plate 115 at resonance is orthogonal 133 to the polarization state 129. This orthogonal polarization is transmitted through the lens 114 to produce polarization state 134 which is then spatially translated by walk-off plate 113 to produce polarization state 136.

The utilisation of the wedge 115 allows a wavelength offset and a phase offset to be introduced. The wavelength offset can be introduced by the different angles emitted from the wedge 115 and the phase offset is introduced by the different path lengths for the two polarization states 124, 125. Only the 90° rotated light is recollected by the wedge 115 so a quarter waveplate or Faraday rotator 116 is used to orient the light so as to capture the light after the wedge. The axis of the wedge 115 and GT resonator axis should differ by 45°.

Turning now to FIG. 18, there is illustrated an exploded perspective view of a further arrangement 140 which again utilises the functionality of a GT resonator to provide for filtering functions.

In the arrangement 140, input and output fibres 141, 142 are provided. A first walkoff plate 144 separates input polarization states and combines the states where required. A lens 146 acts to collimate input and output beams. A birefringent crystal 148 is also provided for manipulating polarization components. A half waveplate 150 provides for polarization manipulation. Finally, a GT resonant liquid crystal cavity 152 is also provided. The resonator 152 has a number of separated electrode areas e.g., 153, 154, 155. The electrodes are provided so as to independently control the birefringence within the GT cavity 152 and therefore independently control the cavities resonant frequency.

Starting with the up polarization at the input fibre 141, both polarization states are present 160. The walk-off plate 144 separates them into spatially distinct polarization states 161, 162. Taking the case of the horizontal polarization state 162 only, (the vertical 161 can be treated analogously), the light 162 is collimated by lens 146 to produce light 163. The light 163 then is separated into orthogonal components 165, 166 by the birefringent plate 148 which is placed at a 45° offset to the horizontal axis. One of the components 165 then traverses a half waveplate 150 before being projected onto the surface of the GT resonator 152 under the control of the electrode 153. The reflected beam 167 again traverses the quarter waveplate 150 and then traverses the birefringent plate 148 substantially along the path 169. The other polarization component 166 exits the birefringent plate 148 and is reflected 170 by the GT resonator 152. It again traverses the birefringent plate 148. Upon exiting the birefringent plate, for the non-resonant condition, the polarization state is vertical 171. The return light is further collimated by the lens 146 so as to produce polarization 172 which then is spatially translated 173 by the walk-off plate 144 so as to be output at fibre 142.

At resonance, the polarization state output from birefringent is horizontal and remains horizontal 174 upon traversing the lens 146, and hence the resonant light will be transmitted through the walk-off plate 144 without translation 175 thereby missing the output waveguide 142.

In this case, the two GT reflections 167, 170 are physically separated from each other and so they can be electronically tuned individually. The half waveplate 150 acts to equalise the polarization states 167, 170 prior to the GT resonator 152. The GT resonator can then comprise a birefringent cavity such as liquid crystal. The use of the two separated polarizations 167, 170 means that each polarization can be tuned individually.

The birefringent crystal 148 can comprise a component crystal including two walk-off plates separated by a half waveplate with an axis at 45°. This allows for less wavelength dependence of the phase of light upon recombining and reduced polarization mode dispersion.

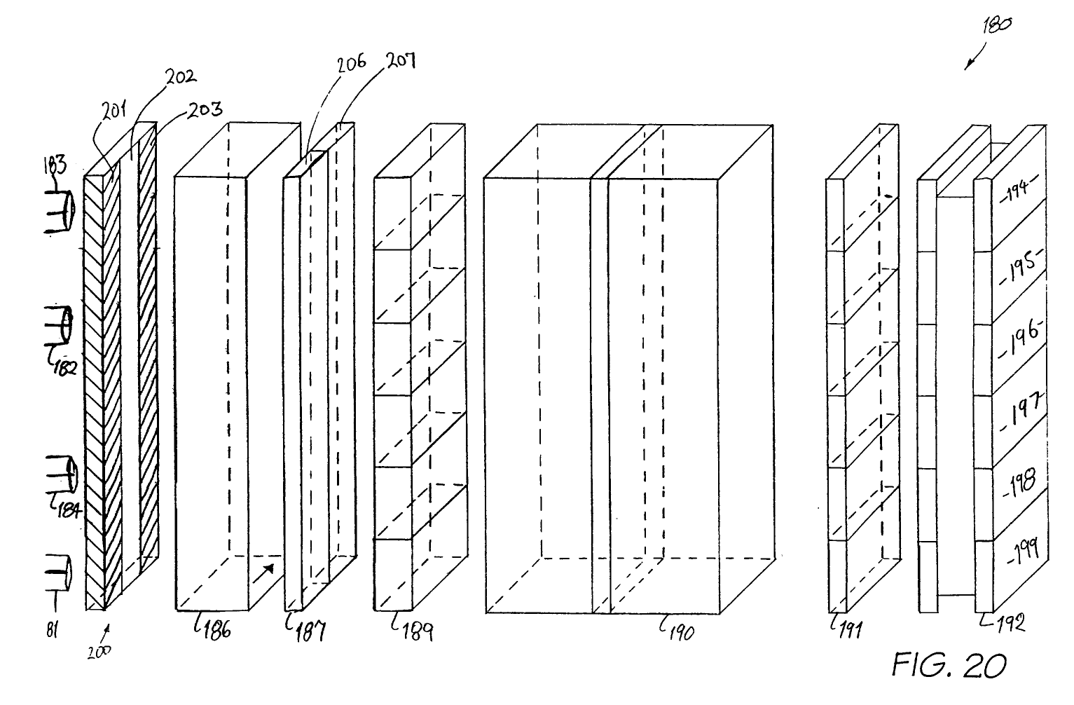

Turning to FIG. 20 there will now be discussed a further arrangement 180. In the arrangement 180, there is provided a reflective demultiplexer, which is of low cost and easily packaged. In this arrangement 180, there is provided an input port 181 and output port 182 and two drop channels 183, 184.

The device includes a first walk-off crystal 186 for separating polarization states horizontally. Next, two halfway plates 187 having their optical axes oriented +/−22.5° to horizontal are provided to equalize each polarization state 45° to horizontal. Subsequently, a phase controller 189 is provided. The phase controller 189 ensures a variable phase delay between vertical and horizontal components of the transmitted light. It is comprised of several independently controlled cells. Next, a walk-off composite 190 is provided, which ensures vertical walk-off of both vertical and horizontal components without relative phase delay. Next, a reciprocal polarization rotator 191 is provided to align vertical and horizontal components, say, vertically (and rotate them both by 90° when non-blocking tuning is required). It is also comprised of several independently controlled cells. This is followed by birefringent GT resonator 192, which has its optical axes aligned vertically and horizontally and has a series of independently controlled electrodes 194-199.

When aligned components are reflected back from two different parts of GT resonator 192 with slightly different wavelength dependent phase shifts they reciprocally traverse back and are spatially recombined by walk-off composite 190, while polarization controller 189 gives one of the components an additional π phase shift. The same happens to the other polarization state. Now each of the polarization states becomes wavelength dependent, so walk-off crystal 186, acting as an analyzer, recombines the light into the drop fiber only if its polarization states are unchanged, and further separates its states if they have been 90° rotated. The slit mirror 200 sends them back into the device, and the dropped light in the middle transparent strip has a strong wavelength dependency.

To achieve tuning of the drop channel without disturbing the other channels, the polarization rotator 191 aligns and rotates both components by 90° to become horizontal. In this case, they are reflected from the birefringent GT resonator 192 without acquiring any wavelength dependent phase shifts, no matter what voltage is applied to its electrodes. When recombined by walk-off composite 190 with additional π phase shift to one of the component by polarization controller 189, they produce the polarization state, which is 90° rotated in regard to the initial one for all wavelengths. The same happens to another polarization state. So, no light is sent into the drop channel, thus making it possible to tune the respective parts of GT resonator 192 without disturbing the main signal. The above discussion illustrates a more general method for tuning an add or drop filter between different channels (wavelengths) without affecting significantly the other (express) channels. When a channel is being dropped, the GT resonator provides a wavelength dependant polarization function to the input light (polarization encoding of wavelength) which can be controlled by adjusting the input polarization states to be in a first state such that two sub-components receive a portion of the light.

The method for tuning the wavelength consists of the following general steps:

1. Firstly, the input polarization is manipulated to remove the wavelength dependence. This can be done by aligning the axis of input polarization to a second state substantially aligned to the axis of the polarization sub-components (i.e., Removal of polarization encoding).

2. The GT resonator can be now tuned to a different resonant wavelength without significantly affecting the traffic travelling through device or the light travelling to the other drop paths or from other add paths.

3. The add or drop functionality can be now reinstated at a different wavelength by readjusting the polarization to be in the first state (reinstatement of polarization encoding).

Because of the shape of the filtering function and the fact that it is reflective, the device can be configured to multiply reflect and so achieve even greater levels of extinction between the filtered channel and all other channels.

A double pass reflection can be used to achieve extremely high extinction. In this case the other light is discarded by walking off. By way of example we can use the first implementation that can be used with standard Etalon based cavities such as are well known and can be produced using MEMs, piezo-electric or thermal tuning. In this case the coalesced polarizations from the “drop” channel is reflected and the “express” light is not reflected but transmitted/absorbed or scattered. The drop light can then pass a second time (and so on) improving the spectral characteristics before being captured by a second lens. An additional quarter wave-plate is positioned to ensure that any unwanted reflected light from the express path is not recoupled into the “drop” path.

By choice of a suitable cavity and reflection coefficients it is possible to produce an add/drop filter for adding or dropping 1 in every N channels. For example, a 400 GHz cavity could be chosen to select a 50 GHz spaced channel with a FSR of 400 GHz. An appropriate reflectivity of 80 percent with delta resonance of 20 GHz could achieve a 3 bB band width of 25 GHz and 25 dB extinction for nearest neighbour.

It will be apparent that the drop process can be partially applied to the drop channel, thereby producing a filtering effect. Hence the proposed arrangements can be used for the simpler task of producing a blocking filter which attenuates the light at particular channels for the purpose of channel equalisation or to stop through cross-talk in add/drop architectures.

In a modification to the arrangement of FIG. 20, all the drop channels can be configured to be orthgonal to the express path polarization state after multiple reflections and to separate only once achieving a drop function which places all the drops into a single fibre. This is of value in the case where several channels need to be dropped from on fibre and routed to a common destination.

This may have some advantages in some system architectures and the functionality is sometimes known as a wavelength selective switch.

The polarization filtering concept can also be applied to laser cavities where it provides the advantage of giving a simple wavelength selective element into a given polarization state that is reflective, tunable and provides the additional benefit of maximising the output coupling through the element at the wavelength of interest to increase the extinction of the output (side mode suppression).

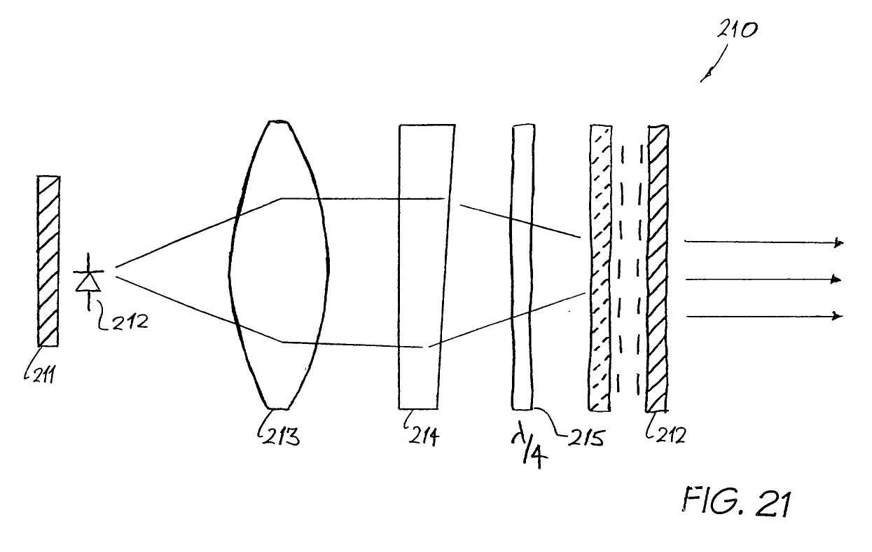

An example of such an arrangement is illustrated in FIG. 21, which shows a diode laser cavity formed between a first mirror 211 and a second GT resonator 210 which has less than 100% reflectivity. Between the two elements 211, 212, there is formed an LED diode 212, a lens 213, a birefringent wedge 214, a quarter wave plate 215 and a GT resonator 212. The resonant cavity, through the use of the wedge, quarter wave plate and GT resonator, provides wavelength selective feedback in that only the selected tuned wavelength is fed back from one end of the cavity to the other. Hence, only light at the selected resonance point will return to the cavity at the same polarization state and hence the tuning of the laser will be centred on the wavelength of maximum feedback. By using a tunable cavity, the arrangement can be used for locking onto a specific wavelength or a group of wavelengths such as provided by the ITU standards. This can be implemented by providing a tunable GT etalon resonator. The tuning can be implemented by thermal expansion of the cavity, piezo electric tuning, electrooptic tuning or other techniques as are well understood. Locking onto a specific wavelength can be achieved by external cavity feedback techniques or by combining a second (Fabry Perot) etalon within the laser cavity with a Free spectral range equal to the desire channel spacing.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

What is claimed is:

1. A method of filtering an input optical signal, the method including the step of:
(a) utilising a relative resonant wavelength shift in the phase response of a Gires-Tournois resonator to produce a corresponding spatial separation in a predetermined wavelength range of said input optical signal.

2. A method as claimed in claim 1 wherein the method further includes the step of:
(b) projecting substantially orthogonal beams onto the surface of a Gires-Tournois resonator at slightly different angles of incidence and utilising the phase difference in the phase response of the orthogonal beams to spatially separate said predetermined wavelength range.

3. A method as claimed in claim 2 wherein a birefringent wedge is utilised to separate an input beam into the substantially orthogonal beams for projection onto the surface of the Gires-Tournois resonator.

4. A method of filtering an input optical signal, the method including the steps of:
(a) imparting a relative phase delay to a predetermined wavelength range of an input optical signal;
(b) spatially separating portions of said optical signal based upon the relative phase delay of components of said optical signal.

5. An apparatus for filtering a first optical signal from a series of optical signals the apparatus comprising:
an input optical waveguide;
a first polarization translation element spatially translating substantially orthogonal polarization states emitted from said input optical waveguide so as to produce spatially separated orthogonal states;
a first birefringent wedge for separating at least one of said substantially orthogonal polarization states into further sub components having different trajectories;
a polarization manipulation element for optionally applying a polarization manipulation to said sub components;
an optical phase delay element for applying a wavelength dependant phase delay to said sub components;
a second birefringent wedge for combining said separated sub components so as to produce a combined component;
a second polarization translation element for spatially translating the combined component depending on its polarization state; and
wherein light from said first optical signal is transmitted towards a first spatial output location and light from said series of optical signals is transmitted to a second spatial output location.

6. An apparatus as claimed in claim 5 wherein the optical phase delay element comprises a Gires-Tournois resonator.

7. An apparatus as claimed in claim 5 wherein the optical phase delay of said optical phase delay element is tunable.

8. An apparatus as claimed in claim 5 wherein said optical phase delay element comprises a Gires-Tournois resonator.

9. An apparatus as claimed in claim 8 wherein the optical phase delay of said Gires-Tournois resonator is tunable.

10. An apparatus as claimed in claim 8 wherein the phase delay of orthogonal polarization states projected onto said Gires-Tournois resonator are independently tunable.

11. An apparatus as claimed in claim 10 wherein one of said orthogonal polarization states is tunable by alteration of an electric field across a liquid crystal and the other is tunable by changing the dimensions of said cavity.

12. An apparatus as claimed in claim 9 wherein said Gires-Tournois resonator includes a liquid crystal filled cavity.

13. An apparatus as claimed in claim 5 wherein said polarization manipulation element imparts a tunable polarization manipulation to said sub-components.

14. An apparatus as claimed in claim 5 further comprising an output waveguide located at the position of at least one of said first spatial output location or said second spatial output location.

15. An apparatus as claimed in claim 5 further comprising a polarization rotation element between said second birefringent wedge and said second polarization translation element for applying a half wave manipulation to said combined component.

16. An apparatus as claimed in claim 5 further comprising a polarization rotation element between said first polarization translation element and said first birefringent wedge for applying a half wave manipulation to said spatially separated orthogonal polarization states.

17. An apparatus as claimed in claim 5 further comprising a collimating lens for collimating the output from said input optical waveguide.

18. An apparatus as claimed in claim 5 wherein said first polarization translation element also acts as said second polarization translation element.

19. An apparatus as claimed in claim 5 wherein said first birefringent wedge also acts as said second birefringent wedge.

20. An apparatus as claimed in claim 5 wherein said device acts in a reflective mode with said input optical waveguide and said first spatial output location are at a first proximal end of said device and said optical phase delay element is located at a second distal end of said device.

21. An apparatus for filtering a first optical signal from a series of optical signals the apparatus comprising:
an input optical waveguide;
a first polarization translation element spatially translating substantially orthogonal polarization states emitted from said input optical waveguide so as to produce spatially separated orthogonal states;
a first birefringent element for separating at least one of said substantially orthogonal polarization states into further sub components having different trajectories;
a polarization manipulation element for applying a polarization manipulation to one of said sub components;
at least one optical phase delay element for independently applying a wavelength dependant phase delay to each of said sub components;
a second birefringent element for combining said separated sub components so as to produce a combined component;
a second polarization translation element for spatially translating the combined component depending on its polarization state; and
wherein light from said first optical signal is transmitted towards a first spatial output location and light from said series of optical signals is transmitted to a second spatial output location.

22. A system as claimed in claim 21 wherein said polarization manipulation element comprises a quarter wave plate.

23. A laser cavity including:
a first reflector at a first end of said cavity;
a light pump emission source;
a first birefringent element for projecting substantially orthogonal polarizations of light in slightly different directions;
a first polarization rotation element adapted to apply a predetermined polarization manipulation to said projected orthogonal polarizations;
a partially reflective optical phase delay element for applying a phase response to reflected portions of said projected orthogonal polarizations and outputting a transmitted portion of said projected orthogonal polarizations.

24. A laser cavity as claimed in claim 23 wherein the light reflected from said optical phase delay element traverses a second polarization rotation element upon reflection.

25. A laser cavity as claimed in claim 23 wherein the light reflected from said optical phase delay element traverses a second birefringent element upon reflection.

26. A laser cavity as claimed in claim 25 wherein the light reflected from said optical phase delay element traverses a second polarization element before traversing said second birefringent element.

27. A laser cavity as claimed in claim 24 wherein said first and second polarization rotation elements are the same element.

28. A laser cavity as claimed in claim 24 wherein said first and second polarization rotation elements are quarter wave plates.

29. A laser cavity as claimed in claim 23 wherein said partially reflective optical phase delay element comprises a Gires Tournois (GT) resonator.

30. A laser cavity as claimed in claim 29 wherein said Gires Tournois resonator has a tunable phase delay.

31. A laser cavity as claimed in claim 23 further including:
a focussing element for collimating light from said light pump emission source.

32. A method of providing a quality laser output source, said method including the steps of:
(a) within a resonant cavity of the laser device, utilising a series of elements so as to impart a selective polarization manipulation to a predetermined wavelength range;
(b) utilising said selective polarization manipulation of said predetermined wavelength range in a feedback loop so as to tune said laser to said predetermined wavelength range.

33. A method as claimed in claim 32 wherein said series of elements include a birefringent wedge, a quarter wave plate and a partially reflective optical phase delay element.

34. A method as claimed in claim 33 wherein said partially reflective optical phase delay element comprises a Gires Tournois resonator.

35. A device for selecting at least a first optical signal from a series of optical signals, the device including:
an input port;
at least a first output port;
a photonic manipulation unit comprising:
a first polarization separation element for spatially separating and aligning light orthogonal polarization states emitted from said first output port to formed an aligned polarization signal;
a first phase controller for providing a variable phase delay between the components of the aligned polarization signal so as to form a delayed polarization signal;
a first walkoff composite element for walking off separate components of said delayed polarization signal so as to form a walked off signal, said walk off signal including further sub components having different trajectories;
an optical phase delay element for applying a wavelength varying phase response to said walked off signal to produce phase varying optical signals;
a second walkoff composite element for combining said phase varying optical signals so as to produce a polarization varying optical signal including a polarization state variation for a first predetermined range of wavelengths relative to a second predetermined range of wavelengths of said polarization varying optical signal;
a second polarization separation element for combining said first predetermined range of wavelengths emitted from said first output port; and
a reflective element including a series of reflective strips, wherein light of the second predetermined range of wavelengths is reflected back through said photonic manipulation element.

36. A device as claimed in claim 33 wherein the light of the second predetermined range of wavelengths is reflected back through said photonic manipulation unit where it is combined at a second output port.

37. A device as claimed in claim 33 wherein the light of the second predetermined range of wavelengths is reflected back through said photonic manipulation unit wherein a third predetermined range of wavelengths is separated from said second range of wavelengths, where it is combined at a third output port, with the remaining light from said second predetermined range of wavelengths being combined a second output port.

38. A device as claimed in claim 33 wherein said first predetermined range of wavelengths is variable.

39. A device as claimed in claim 33 wherein said photonic manipulation unit further comprises a first polarization alignment element for polarization state aligning of said walked off signal so as to form aligned polarization signals.

40. A method of separating a first optical signal from a series of optical signals, the method including the step of:
interfering two polarization sub-components of said series of optical signals, said sub-components having differing phases in a narrow band around said first optical signal.

41. A method as claimed in claim 40 wherein said differing phases are formed by different angular propagation through a Gires Tournois interferometer.

42. A method as claimed in claim 40 wherein said differing phases are formed by separating linearly polarised input light into said two polarization sub-components having slightly differing trajectories; and projecting said polarization sub-components against a Gires Tournois interferometer.

43. A method as claimed in claim 41 wherein said Gires Tournois interferometer has an adjustable phase response.

44. A method of manipulating an input optical signal including the step of:
(a) inducing a relative resonant wavelength shift in the phase response of two polarization sub-components of said optical signal.

45. A method as claimed in claim 44 wherein said inducing step includes projecting said two polarization sub-components against a Gires Tournois resonator at slightly different angles of incidence.

46. A method as claimed in claim 44 further including the step of:
(b) interfering the two polarization subcompents together so as to produce a first output signal having a polarization variation with respect to wavelength.

47. A method as claimed in claim 44 further including the step of:
(c) utilising said polarization variation to spatially separate different wavelengths of said input signal.

48. A method as claimed in claim 44 wherein said method is utilised in separating a first wavelength signal from a series of wavelength signals.

49. A method as claimed in claim 44 wherein said relative resonant wavelength is tunable.

50. A method of tuning a wavelength selective optical device including a polarization manipulation element, said method including the steps of:
(a) initially setting the polarization manipulation element to a first state, including a polarization encoding of the wavelength;
(b) adjusting the polarization manipulation element to reduce or remove the polarization encoding of wavelength selectivity;
(c) wavelength tuning the phase response;
(d) readjusting the polarization manipulation element to said first state, including a polarization encoding of the wavelength.

51. A method as claimed in claim 50 wherein said step (c) comprises manipulating the phase response of a Gires-Tournois resonator.

52. A method as claimed in claim 51 wherein said step (b) includes aligning the input polarisation state to an axis of the Gires-Tournois resonator.

53. A method as claimed in claim 50 wherein said polarisation manipulation element comprises a variable polarisation rotation element.

54. A method as claimed in claim 1 wherein said filtering provides a non-interleaved response.
